(19) United States
(12) Patent Application Publication
(10) Pub. No.: US 2014/0362488 A1
(43) Pub. Date: Dec. 11, 2014

(54) SHORT-CIRCUIT PROTECTION STRUCTURE

(71) Applicant: Suzhou Poweron IC Design Co., Ltd, Suzhou City (CN)

(72) Inventors: Ping TAO, Suzhou City (CN); Haisong Li, Suzhou City (CN); Hualong Zhuang, Suzhou City (CN); Yangbo Yi, Suzhou City (CN)

(21) Appl. No.: 14/226,719

(22) Filed: Mar. 26, 2014

(30) Foreign Application Priority Data
Jun. 9, 2013 (CN) 201310230700.5

(51) Int. Cl. H02H 3/08

(52) U.S. Cl. CPC H02H 3/08
USPC 361/101

(57) ABSTRACT

A short-circuit protection structure comprises first and second high-voltage transistors, a control circuit, a first current sampling resistor for the first transistor and a second current sampling resistor for the second transistor. The control circuit controls switching period and duty cycle of the first transistor and the second transistor, a drain terminal of the first transistor is connected to a drain terminal of the second transistor, a source terminal of the first transistor is connected to the first current sampling resistor, and a source terminal of the second transistor is connected to the second current sampling resistor; a gate terminal of the first transistor and a gate terminal of the second transistor are connected to a driver stage of the control circuit. The size of the second transistor is smaller than the first transistor, and the current of the first transistor is sampled by the second transistor.

### CROSS-REFERENCE TO RELATED APPLICATIONS

The present invention claims priority from Chinese Patent Application Ser. No. 201310230700.5 filed Jun. 9, 2013, which is incorporated herein by reference for all purposes.

### FIELD OF THE INVENTION

The present invention relates to a short-circuit protection structure applicable to integrated circuits for power management, and belongs to the technical field of power semiconductor.

### BACKGROUND OF THE INVENTION

As shown in FIG. 1, the traditional structure of the switching mode power supply comprises a control circuit 1 and an output stage transistor 2. Said control circuit 1 obtains the voltage Vs1 of a sampling resistor Rs1 and the system-level feedback signal Vfb, and controls the switching time and the duty cycle of said output stage transistor 2 by adopting an internal-loop algorithm, so as to realize the stable voltage output and current output of the system. No matter whether the output stage transistor 2 and control circuit 1 are integrated into the same chip or not, usually the sampling resistor Rs1 is not integrated into the chip in order to obtain more stable sampling current, because the temperature characteristic and the production stability of the resistor while being set outside of the chip are better than those of the internal resistor. However, when the sampling resistor Rs1 is not integrated with the control circuit 1 or the output stage transistor 2, short circuiting of the sampling resistor Rs1 that occurs during the actual production process is inevitable, and the short circuiting may be due to solder bridging, broken resistors, PCB bridging, short circuiting of pins of the chip and so on.

When the Rs1 is shorted, the resistance of Rs1 gets so small that the voltage Vs1 will not be able to reach the reference voltage Vref1 of the internal comparator, and the over-current protection for the output stage transistor by the control circuit will be a failure, the output stage transistor will work at the maximum duty cycle, and the output stage transistor will work in the saturation region (high Vds and large Ids) which is beyond its safe operating area, resulting in breakdown of the output stage transistor even resulting in damage of the whole system. FIG. 2 shows signal waveforms of the traditional switching mode power supply without short-circuit protection when the sampling resistor is shorted.

### SUMMARY OF THE INVENTION

A target of the present invention is to overcome the defects of the prior art, so as to provide a short-circuit protection structure for a switching power supply system which has high reliability and low system cost, and to prevent the system or chip from being destroyed when the current sampling resistor for the output stage transistor is shorted.

The target of the present invention is achieved by the following technical solutions:

A short-circuit protection structure comprises a first transistor, a second transistor, a control circuit, a first current sampling resistor for the first transistor and a second current sampling resistor for the second transistor, said control circuit controls switching time and duty cycles of said first transistor and said second transistor; current of said first transistor is sampled by said second transistor; a drain terminal of said first transistor is connected to a drain terminal of said second transistor, a source terminal of said first transistor is connected to the first current sampling resistor and a source terminal of said second transistor is connected to the second current sampling resistor; a gate terminal of said first transistor and a gate terminal of said second transistor are connected to a driver stage of said control circuit, both said first transistor and said second transistor are high voltage transistors; and a size of said second transistor is smaller than a size of said first transistor.

Preferably, said second transistor, said second current sampling resistor for said second transistor are integrated with said control circuit.

Preferably, said first current sampling resistor for said first transistor is independent of said control circuit.

Preferably, said first transistor is integrated with said control circuit; and said first transistor is a vertical high voltage transistor or a lateral high voltage transistor.

Preferably, said first transistor is integrated with said control circuit; said first transistor is a vertical high voltage transistor; said first transistor and said second transistor are integrated into a same silicon chip; and said first transistor and said second transistor have same structure in order to obtain a constant current factor K.

Preferably, an isolation structure is provided between said first transistor and said second transistor.

Preferably, said first transistor is integrated with said control circuit; said first transistor is a lateral high voltage transistor; said first transistor and said second transistor are integrated into a same silicon chip; and said first transistor and said second transistor have same structure in order to obtain a constant current factor K.

Preferably, said first transistor is independent of said control circuit; and said first transistor is a vertical high voltage transistor or lateral high voltage transistor.

Preferably, said first transistor is independent of said control circuit; said first transistor is a vertical high voltage transistor; and said second transistor is a lateral high voltage transistor.

Preferably, said first transistor is independent of said control circuit; said first transistor is a lateral high voltage transistor; and said second transistor is a lateral high voltage transistor.

The prominent substantive features and notable progress of the technical solutions of the present invention are mainly manifested in following aspects:

1. In the power supply system, the short-circuit protection device is capable of protecting the output stage transistor effectively, and preventing the chip or the system components from being broken due to short circuiting of the current sampling resistors; when the first current sampling resistor for the output stage transistor is shorted, a short-circuit signal could be detected from the second current sampling resistor for the sampling transistor so as to latch the chip off; additionally, since the second current sampling resistor for the sampling transistor is integrated into the chip, it will not be shorted; whereby the short-circuit protection for the sampling resistor of the AC-DC chip is realized, the reliability of the chip is improved and the failure rate of the chip is reduced.

2. The power supply chip adopting the technical solution of the present invention has a reduced failure ratio of production and significantly improved product reliability.

3. The short-circuit protection structure is simple. When the power supply chip adopting the technical solutions of the present invention is applied in the power system, the short-circuit protection for the sampling resistor can be realized without any additional system components, what's more, the cost advantage of the system is noticeable.

### BRIEF DESCRIPTION OF THE DRAWINGS

The technical solutions of the preset invention will be described in more details with reference to the accompanying drawings:

FIG. 1 is a structural diagram of a prior art switching mode power supply;

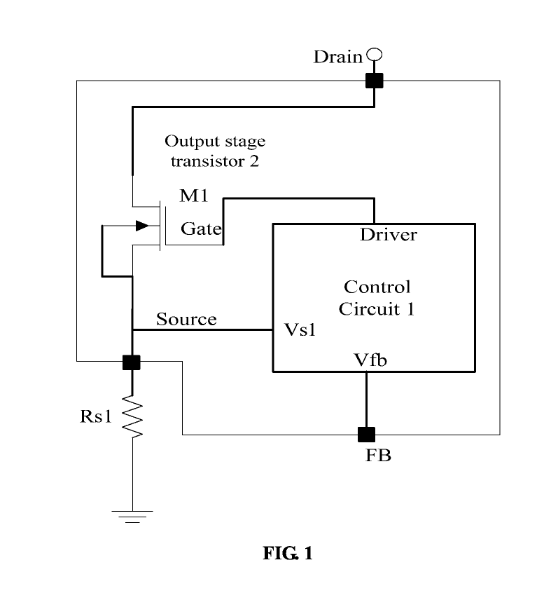

FIG. 2 shows signal waveforms of a prior art switching mode power supply without short-circuit protection when the sampling resistor is shorted;

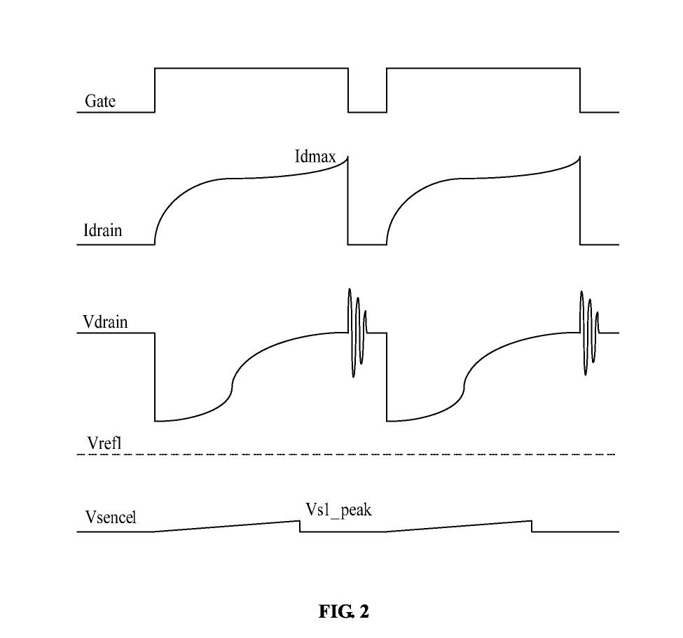

FIG. 3 is a diagram illustrating the short-circuit protection structure of the present invention;

FIG. 4 shows signal waveforms of the switching mode power supply with the short-circuit protection structure of the present invention when the current sampling resistors are in normal working state;

FIG. 5 shows signal waveforms of the switching mode power supply with the short-circuit protection structure of the present invention when the current sampling resistors are shorted;

FIG. 6 is a structural diagram of the vertical transistor integrated with the control circuit;

FIG. 7 is a sectional diagram of the vertical transistor integrated with the control circuit;

FIG. 8 is a structural diagram of the lateral transistor integrated with the control circuit;

FIG. 9 is a diagram illustrating the lateral sampling transistor integrated with the control circuit.

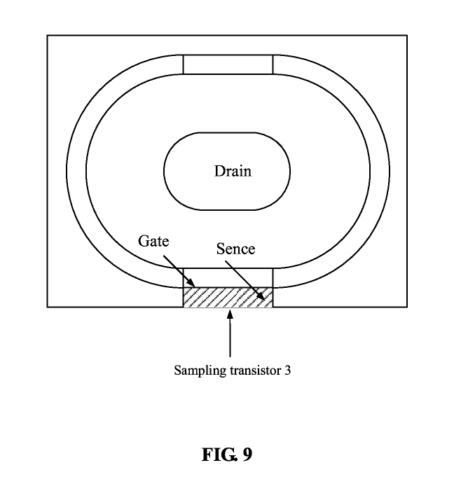

### DETAILED DESCRIPTION OF THE PREFERRED EMBODIMENTS

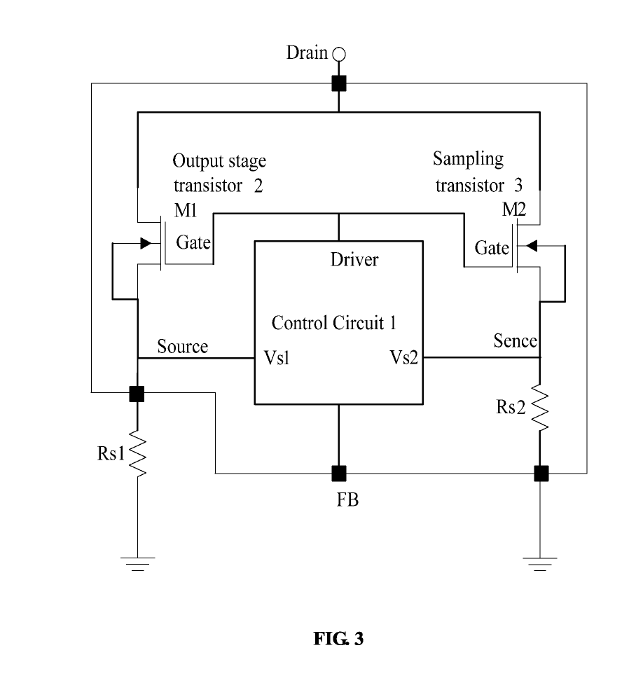

As shown in FIG. 3, the short-circuit protection structure comprises an output stage transistor 2 (M1), and a first current sampling resistor (Rs1) for the output stage transistor 2; a sampling transistor 3 (M2) whose size is far smaller than the size of the output stage transistor 2, and a second current sampling resistor (Rs2) for the sampling transistor 3; and a control circuit 1. Wherein, the output stage transistor 2 (M1) serves as the output stage power switch of the short-circuit protection structure, the switching time and duty cycles of the output stage transistor 2 and the sampling transistor 3 are controlled by the control circuit 1, the drain terminal of the output stage transistor 2 is connected to the drain terminal of the sampling transistor 3, the source terminal of the output stage transistor 2 is connected to the first current sampling resistor (Rs1), the source terminal of the sampling transistor 3 is connected to the second current sampling resistor (Rs2), and the gate terminal of the output stage transistor 2 and the gate terminal of the sampling transistor 3 are connected to the driver stage of the control circuit 1. Both the output stage transistor 2 and the sampling transistor 3 are high voltage transistors, and the size of the sampling transistor 3 is smaller than the size of the output stage transistor 2. The current of the output stage transistor 2 is sampled by the sampling transistor 3. The current threshold of said short-circuit protection device is determined by the ratio of the size of the sampling transistor 3 to the size of the output stage transistor 2, and by the resistance of the current sampling resistor of the control circuit.

Wherein, the sampling transistor 3, the second current sampling resistor (Rs2) for the sampling transistor 3 and the control circuit 1 are integrated into one chip; the output stage transistor 2 (M1) may be integrated into the chip, or may be set independently outside the chip as a discrete component; the first current sampling resistor (Rs1) for the output stage transistor is not integrated with other elements but set outside the chip independently.

When the first current sampling resistor (Rs1) for the output stage transistor is shorted, a short-circuit signal will be detected from the second current sampling resistor (Rs2) for the sampling transistor so as to latch the chip off. Meanwhile, since the second current sampling resistor (Rs2) for the sampling transistor is integrated into the chip, it will not be shorted. Consequently, the short-circuit protection for the sampling resistor of the AC-DC chip is realized, the reliability of the chip is improved and the failure rate of the chip is reduced.

When the gate voltage is high , the output stage transistor 2 (M1) and sampling transistor 3 (M2) are conducted at the same time, the current IdsM1 flows through the output stage transistor 2 (M1) and the current IdsM2 flows through the sampling transistor 3 (M2), and the total current Idrain that flows through the drain terminal is obtained by the formula: Idrain=IdsM1+IdsM2. The formula IdsM1=k×IdsM2 is ensured by designing the two transistors inside the chip. The size of the sampling transistor 3 (M2) is far smaller than the output stage transistor 2 (M1), therefore K is far greater than 1, and Idrain is equivalent proximately to IdsM1 (Idrain≈IdsM1). Under the effect of the inductive load, the total current flowing through the drain terminal changes at an approximate fixed slope. The current slope is as follows:

$$\frac{d {I}_{drain}}{d t} = \frac{{V}_{IN}}{L}$$

Wherein, V_{IN} is the input voltage of the AC-DC system, L is the inductance of the primary side inductor.

In the process mentioned above, when the current IdsM1 flows through the output stage transistor 2 (M1), a component voltage Vs1 across the first current sampling resistor Rs1 for the output stage transistor is calculated by the formula: Vs1=IdsM1×Rs1; when the current IdsM1 flows through the sampling transistor 3 (M2), a component voltage Vs2 across the second current sampling resistor (Rs2) for the sampling transistor is calculated by the formula: Vs2=IdM2×Rs2. Both Vs1 and Vs2 are fed back to the control circuit and respectively compared with internal reference voltages Vref1 and Vref2.

When Vs1 is equal to Vref1 (Vs1=Vref1), then Idmax1 is equivalent proximately to Vref1/Rs1 (Idmax1≈Vref1/Rs1), and the chip goes into the state of over current protection.

When Vs2 is equal to Vref2 (Vs2=Vref2), the Idmax2 is equivalent proximately to K×Vref2/Rs2 (Idmax2=K×Vref2/Rs2), and the chip goes into the state of short-circuit protection.

By means of designing appropriate values of Vref1, Vref2, Rs1, Rs2 and K, it can be ensured that Idmax2 is greater than Idmax1 (Idmax2>Idmax 1) when the chip works normally.

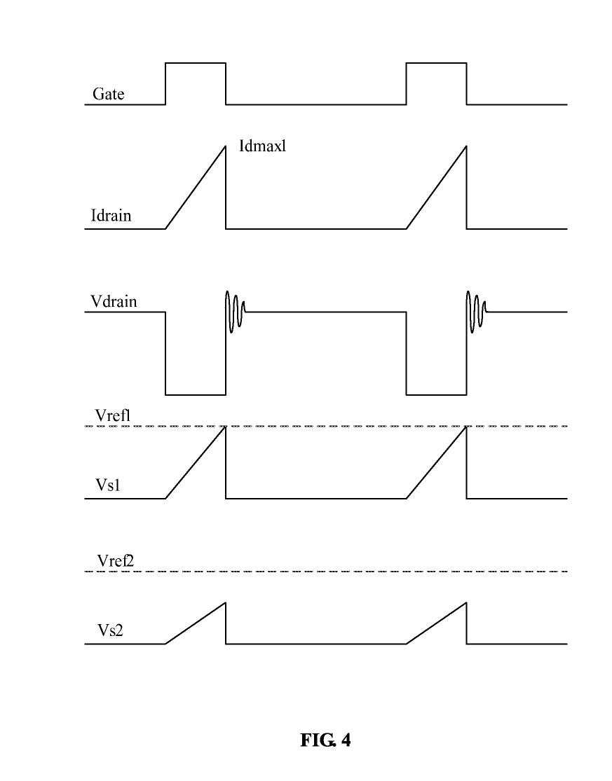

When the system is in the normal operating state, signal waveforms are just as shown in FIG. 4. When the power switch is turned on, the drain voltage gets lower. Under the effect of the inductive load, the current flowing through the drain terminal increases at an approximately fixed slope. Since the design of the system ensures that Idmax2 is greater than Idmax1 (Idmax2>Idmax1), when Vs1 is equal to Vref1 (Vs1=Vref1), then Vs2 is less than Vref2 (Vs2<Vref2) and the chip goes into over-current protection state preferentially. In such a case, the power switch is turned off under the control of the control circuit, and the drain terminal voltage gets higher and the current flowing through the drain terminal drops to zero. The power switch does not turn on until next switching period starts.

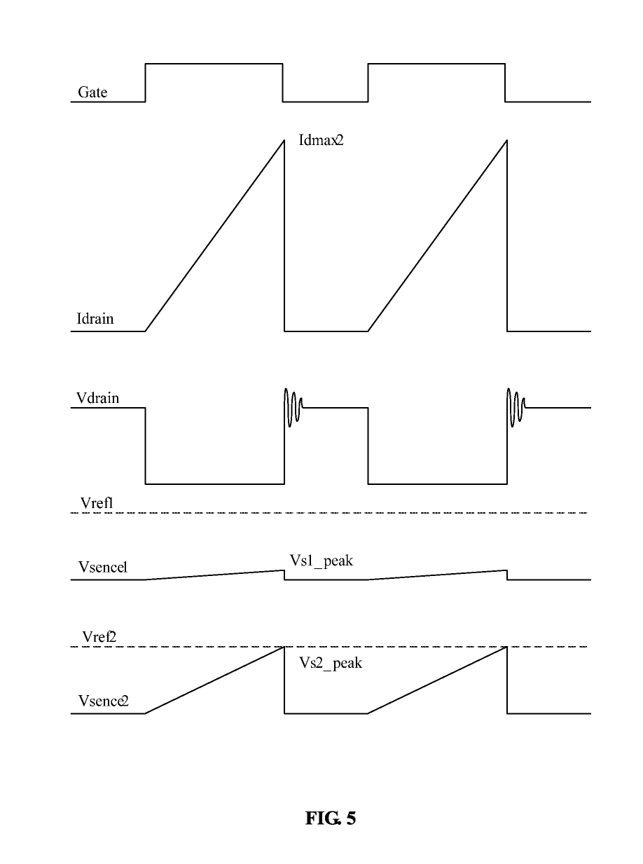

When the first current sampling resistor (Rs1) for the output stage transistor in the system is shorted and the resistance is zero ohm or a smaller value, signal waveforms are just as shown in FIG. 5. When the gate outputs high level, the drain terminal voltage gets lower. Under the effect of inductive load, the current flowing through the drain terminal increases at an approximately fixed slope. Since the first current sampling resistor (Rs1) for the output stage transistor is shorted, when Vs2 is equal to Vref2 (Vs2=Vref2), then Vs1 is less than Vref1 (Vs1<Vref1) and the chip goes into the state of short-circuit protection. In such a case, the control circuit turns off, and the output stage power transistor is turned off, so as to prevent the output stage power transistor from being destroyed due to operating beyond the safe operating area for a long time.

On the basis of different structure and different integration patterns of the first transistor (namely, the output stage transistor 2) and the second transistor (namely, the sampling transistor 3), three specific embodiments are described respectively as follows:

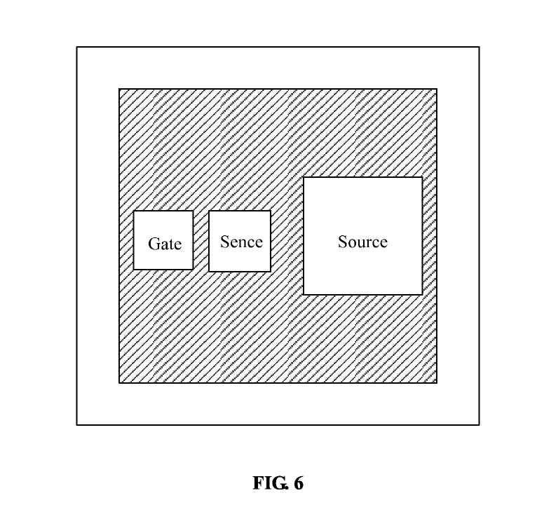

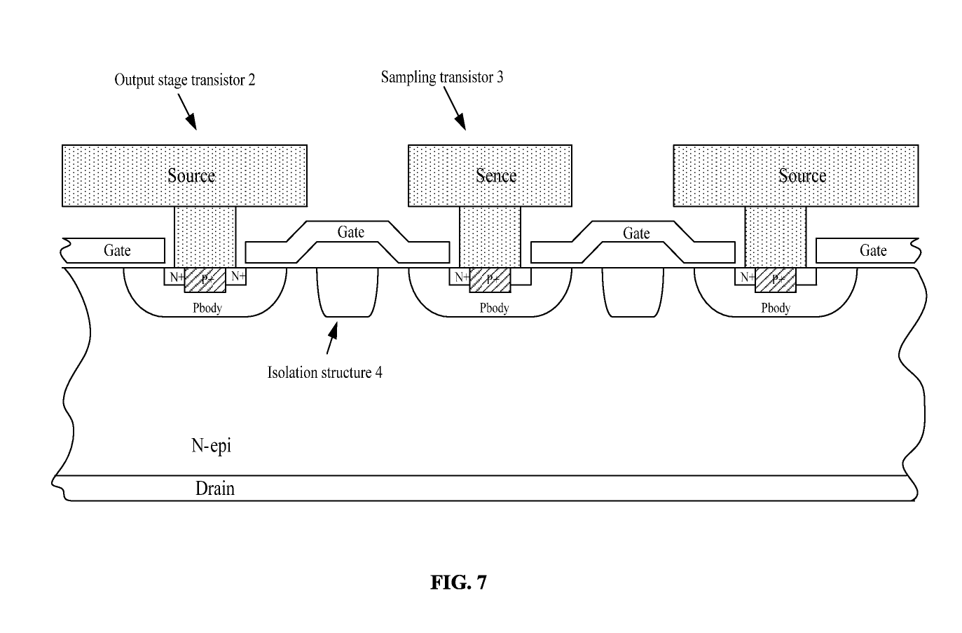

The integration solution of the first embodiment is that a vertical output stage transistor is integrated with the control circuit. When the vertical output stage transistor is integrated, the sampling transistor is provided on said vertical output stage transistor, as shown in FIG. 6. The structure of the sampling transistor 3 is the same as the structure of the output stage transistor 2, in order that the current factor K between the sampling transistor 3 and the output stage transistor 2 is a constant. As shown in FIG. 7, a vertical sectional diagram illustrating the structure of said vertical transistor, the structure of primitive cells of the sampling transistor 3 is the same as that of the output stage transistor 2, and an isolation structure 4 is provided between the output stage transistor 2 and the sampling transistor 3 to prevent the current factor K from drifting due to electric leakage between the two transistors.

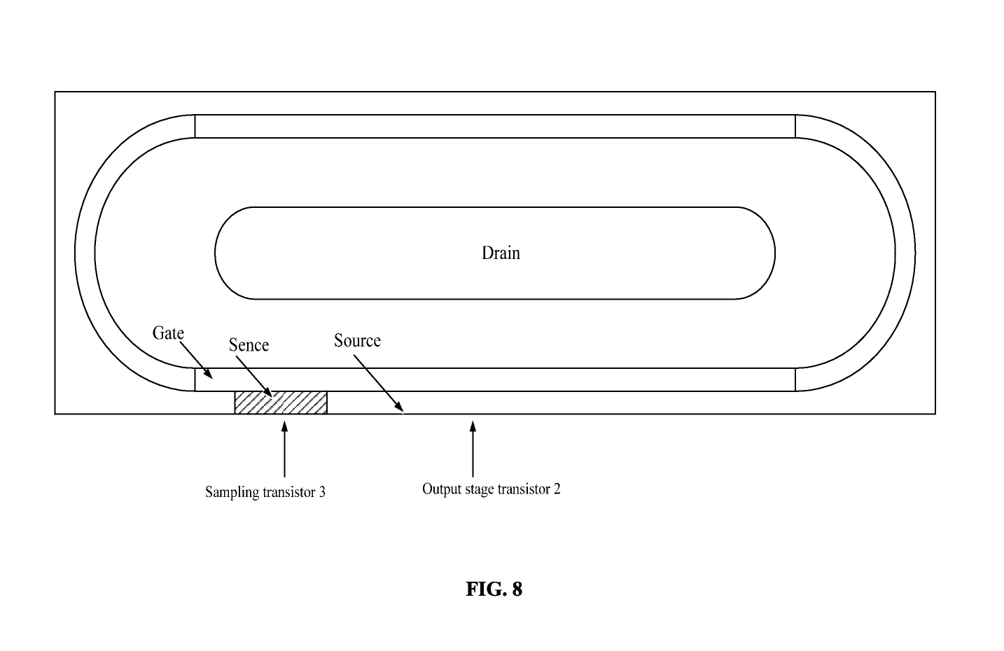

The integration solution of the second embodiment is that a lateral output stage transistor is integrated with the control circuit. When the lateral output stage transistor is integrated, the sampling transistor 3 is provided on said lateral output stage transistor, as shown in FIG. 8. The structure of the sampling transistor 3 is the same as the structure of the output stage transistor 2, in order that the current factor K between the sampling transistor 3 and the output stage transistor 2 is a constant.

The integration solution of the third embodiment is that the output stage transistor is not integrated with the control circuit. The output stage transistor is an independent and discrete component, which can be either a lateral voltage withstand transistor or a vertical voltage withstand transistor. As shown in Figure in 9, the control circuit, the sampling transistor 3 (M2) and the second current sampling resistor (Rs2) for the sampling transistor are integrated together, wherein, the sampling transistor 3 is a lateral transistor. There is not an output stage transistor but a sampling transistor 3 in this integrated device. In the third embodiment, the current factor K is not constant, and the resistance of the second current sampling resistor (Rs2) for the sampling transistor and the voltage Vref2 need to be regulated according to the requirements of the system.

In conclusion, the present invention is capable of protecting the output stage transistor effectively in a power system and preventing components in the chip or in the system from being destroyed due to short circuiting of the current sampling resistors; the power supply chip adopting the technical solutions of the present invention has a reduced failure rate of production and a significantly improved product reliability; the short-circuit protection structure is simple, when the power supply chip adopting the technical solutions of the present invention is applied in the power system, the short-circuit protection for the sampling resistor can be realized without any additional system components, what's more, the cost advantage of the system is noticeable.

It should be understood that what described above are preferred embodiments of the present invention, and it should be understood by those skilled in the art that various improvements and modifications may be made based on the principles of the present invention without departing from the scope of the invention.

What is claimed is:

1. A short-circuit protection structure, comprising a first transistor, a second transistor, a control circuit, a first current sampling resistor for the first transistor and a second current sampling resistor for the second transistor, wherein, said control circuit controls switching time and duty cycles of said first transistor and said second transistor; current of said first transistor is sampled by said second transistor; a drain terminal of said first transistor is connected to a drain terminal of said second transistor, a source terminal of said first transistor is connected to the first current sampling resistor and a source terminal of said second transistor is connected to the second current sampling resistor; a gate terminal of said first transistor and a gate terminal of said second transistor are connected to a driver stage of said control circuit, both said first transistor and said second transistor are high voltage transistors; and a size of said second transistor is smaller than a size of said first transistor.

2. The short-circuit protection structure according to claim 1, wherein, said second transistor, said second current sampling resistor for said second transistor are integrated with said control circuit.

3. The short-circuit protection structure according to claim 1, wherein, said first current sampling resistor for said first transistor is independent of said control circuit.

4. The short-circuit protection structure according to claim 1, wherein, said first transistor is integrated with said control circuit; and said first transistor is a vertical high voltage transistor or a lateral high voltage transistor.

5. The short-circuit protection structure according to claim 1, wherein, said first transistor is integrated with said control circuit; said first transistor is a vertical high voltage transistor; said first transistor and said second transistor are integrated into a same chip; and
said first transistor and said second transistor have same structure in order to obtain a constant current factor K.

6. The short-circuit protection structure according to claim 5, wherein, an isolation structure is provided between said first transistor and said second transistor.

7. The short-circuit protection structure according to claim 1, wherein, said first transistor is integrated with said control circuit; said first transistor is a lateral high voltage transistor; said first transistor and said second transistor are integrated into a same chip; and said first transistor and said second transistor have same structure in order to obtain a constant current factor K.

8. The short-circuit protection structure according to claim 1, wherein, said first transistor is independent of said control circuit; and said first transistor is a vertical high voltage transistor or lateral high voltage transistor.

9. The short-circuit protection structure according to claim 1, wherein, said first transistor is independent of said control circuit; said first transistor is a vertical high voltage transistor; and said second transistor is a lateral high voltage transistor .

10. The short-circuit protection structure according to claim 1, wherein, said first transistor is independent of said control circuit; said first transistor is a lateral high voltage transistor; and said second transistor is a lateral high voltage transistor.
